(19) United States
(12) Patent Application Publication
(10) Pub. No.: US 2021/0155516 A1
(43) Pub. Date: May 27, 2021

(54) USE OF WASTE FATS, OILS AND GREASE (FOG) AND OTHER WASTE HYDROCARBONS IN BIOLOGICAL NUTRIENT REMOVAL WASTEWATER TREATMENT PROCESSES

(71) Applicant: CDT Tech, Inc., Columbia, CT (US)

(72) Inventor: Michael Curtis, Columbia, CT (US)

(73) Assignee: CDT Tech, Inc., Columbia, CT (US)

(21) Appl. No.: 16/830,583

(22) Filed: Mar. 26, 2020

Related U.S. Application Data
(60) Provisional application No. 62/826,234, filed on Mar. 29, 2019.

(51) Int. Cl. C02F 3/02

(52) U.S. Cl. CPC C02F 3/025; C02F 2101/163

(57) ABSTRACT

A method is provided for the denitrification of a substance having nitrate (NO₃—) molecules therein. The method includes collecting waste organic material having fats, oils and grease (“FOG”) therein, and separating the FOG from the collected waste organic material. The FOG is mixed with a saponific reagent thereby initiating a saponification reaction to hydrolyze the FOG to fatty acid salts. A resultant FOG mixture (“RFM”) is formed having stratified layers of one or more fatty acid mixtures (“FAM”) and a glycerol fraction derived mixture (“GFDM”). The GFDM is mixed with the substance wherein heterotrophic bacteria use oxygen from the nitrate (NO₃—) molecules to breakdown the GFDM thereby producing nitrogen gas.

### CROSS-REFERENCE TO RELATED APPLICATION

This application claims the benefit, in accordance with 35 U.S.C. § 119(e), of U.S. Provisional Patent Application Ser. No. 62/826,234; filed on Mar. 29, 2019, which is incorporated herein by reference in its entirety.

### TECHNICAL FIELD

The present invention is directed to the use of waste fats, oils and grease (collectively, “FOG”) and other waste hydrocarbons in biological nutrient removal wastewater treatment processes. The present invention is further directed to an improved method for biological denitrification in a biological denitrification reaction.

### BACKGROUND

Sewage or wastewater generally includes fatty organic materials from animals, vegetables, and petroleum that are not quickly broken down by bacteria. This fat, oil, and grease (i.e., FOG) causes pollution in receiving environments. FOG enters a sewer system from restaurants, residences, and industrial food facilities. Its release into the sewer system results in a continuous build-up that causes eventual blockage of sewer pipes. Physical, chemical, and biological processes are used to remove contaminants and produce treated wastewater that is safe enough for release into the environment.

Wastewater treatment processes may include, for example, using an anaerobic process where microorganisms or enzymes break down biodegradable material in the absence of oxygen. Other wastewater treatment processes may include, for example, using an aerobic biological process where aerobic bacteria digest biological wastes. Saponification is one process used for treating FOG in which triglycerides are reacted with sodium hydroxide or potassium hydroxide to produce glycerol and a fatty acid salt. More particularly, saponification is the alkaline hydrolysis of organic compounds such as fatty acid esters in which the hydrogen in the compound's carboxyl group is replaced with a hydrocarbon group.

The inventor has recognized that improvements in the aforementioned wastewater treatment processes are desirable.

### SUMMARY

In one aspect, the present invention relates to a method for denitrification of a substance having nitrate (NO₃—) molecules therein, the method comprising the steps of: collecting waste organic material having fats, oils and grease (“FOG”) therein; separating the FOG from the collected waste organic material; mixing a saponific reagent with the FOG thereby initiating a saponification reaction to hydrolyze the FOG to fatty acid and forming a resultant FOG mixture (“RFM”) having stratified layers of one or more fatty acid mixtures (“FAM”) and a glycerol fraction derived mixture (“GFDM”); and mixing the GFDM with the substance in an anoxic environment wherein heterotrophic bacteria use oxygen from the nitrate (NO₃—) molecules to breakdown the GFDM thereby producing nitrogen gas.

In one embodiment, the saponific reagent is a plant-based, biodegradable degreaser; and in one embodiment, the plant-based, biodegradable degreaser is a vegetable-based protein mixture. In one embodiment, the resultant FOG mixture (“RFM”) is a flowable liquid byproduct. In one embodiment, the step of mixing a saponific reagent with the FOG is achieved in a reactor with batch dosing of the saponific reagent; and in one embodiment, the step of mixing a saponific reagent with the FOG is achieved in a reactor with continual dosing of the saponific reagent.

In one embodiment, the fatty acid mixture (“FAM”) comprises a fatty acid salt mixture. In one embodiment, the resultant FOG mixture (“RFM”) is bio-reactive in an aerobic processes; and in one embodiment, the resultant FOG mixture (“RFM”) is bio-reactive in an anaerobic processes. In one embodiment, the resultant FOG mixture (“RFM”) comprises a layer of the glycerol fraction derived mixture (“GFDM”) disposed between a comparatively lighter layer of the fatty acid mixture (“FAM”) with respect to the GFDM, and a comparatively heavier layer of the FAM with respect to the GFDM. In one embodiment, the step of mixing a saponific reagent with the FOG includes dosing of the reagent together with a hydroxide for ongoing pH adjustment. In one embodiment, the hydroxide comprises Potassium Hydroxide (KOH). In one embodiment, the glycerol fraction derived mixture (“GFDM”) comprises a bio-reactive dissolved organic carbon mixture.

In one embodiment, ninety percent (90%) to ninety-nine percent (99%) of the FOG dissolves into the resultant FOG mixture (“RFM”) with the balance remaining as near-solid FOG. In one embodiment, the resultant FOG mixture (“RFM”) continues to break down in aerobic systems such that complete oxidation of the RFM is achieved in five to ten days in a static desk bench-top reactor. In one embodiment, the resultant FOG mixture (“RFM”) continues to break down in anaerobic systems such that complete reduction of the RFM is achieved in five to ten days in a static desk bench-top reactor.

In one embodiment, the fatty acid mixture (“FAM”) is introduced into a digester. In one embodiment, the step of collecting FOG includes receiving the fatty acid mixture (“FAM”) that passes through the digester. In one embodiment, the method includes a step in which the resultant FOG mixture (“RFM”) is introduced into an anaerobic digester system where it breaks down thereby producing large quantities of methane on a gram of methane per gram of RFM basis.

### BRIEF DESCRIPTION OF THE DRAWINGS

FIG. 1 is an elevation view of a vessel containing a resultant FOG mixture achieved in accordance with the present invention.

FIG. 2 is a flow diagram of one method for producing a Glycerol Fraction Derived Mixture in accordance with the present invention.

FIG. 3 is a diagram of one method for biological denitrification in accordance with the present invention.

FIG. 4 is a graph showing testing results of the method for biological denitrification of FIG. 3.

### DETAILED DESCRIPTION

In one embodiment of the present invention, certain materials including waste hydrocarbons, specifically fats, oils and grease (i.e., FOG), are treated with a saponification reaction to hydrolyze the FOG to fatty acid salts. These fatty acid salts are produced both in batch and in continuous flow reactors by feeding waste FOG and other hydrocarbons into a reactor with batch or continual dosing of a saponific solution or reagent. The saponification of the FOG produces a concentrated mixture which is highly bio-reactive in aerobic and anaerobic processes, which mixture is referred to herein as a resultant FOG mixture or “RFM.” The RFM includes one or more fatty acid mixtures or fatty acid salt mixtures, which mixtures are collectively referred to herein as “FAM.”

In one embodiment of the present invention, a saponific solution or reagent used for saponification of the FOG is a vegetable-based protein mixture that converts FOG into a flowable liquid byproduct. In another embodiment of the present invention, a saponific solution or reagent used for an enhanced saponification of the FOG is a plant-based, biodegradable degreaser that converts FOG into a flowable liquid byproduct. One such plant-based, biodegradable degreaser is commercially available from Protein Matrix LLC (a New York limited liability company) as Protein Matrix Industrial Grease Remediation (“IGR”). In one embodiment of the present invention, the saponific solution or reagent is a proprietary formulation known as PM-4 and is commercially available from Protein Matrix LLC.

The saponific solution or reagent disrupts the intermolecular forces of FOG molecules and reacts with these molecules on an individual level which prevents the resolidifcation and reagglomeration of FOG that can result from the use of bacterial or enzyme-based products. The reagent reacts with a FOG triglyceride molecule to cleave the large molecule into four separate component pieces: three fatty acid salts and a glycerin molecule. The enhanced saponification caused by use of the plant-based, biodegradable degreaser to treat FOG exhibits a lower activation energy, an increased rate of reaction, an increased rate of completion and produces a pH-neutral RFM wherein resultant components are held in suspension as a flowable byproduct.

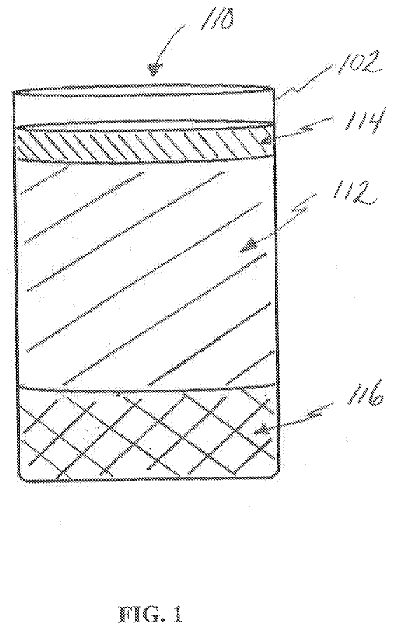

The enhanced saponification of the FOG with batch or continual dosing of the reagent together with ongoing pH adjustment with a hydroxide, such as for example Potassium Hydroxide (KOH), results in a discrete, near solids-free RFM 110 shown in FIG. 1, as accumulated in a vessel or other container 102. A fraction of the RFM 110 is a concentrated and highly bio-reactive dissolved organic carbon mixture similar to glycerol, which mixture is referred to herein as a Glycerol Fraction Derived Mixture or “GFDM.” As shown in FIG. 1, the RFM 110 is a stratified mixture that includes a layer of GFDM 112 disposed between a comparatively lighter layer of FAM 114 (with respect to the GFDM 112) and a comparatively heavier layer of FAM 116 (with respect to the GFDM 112).

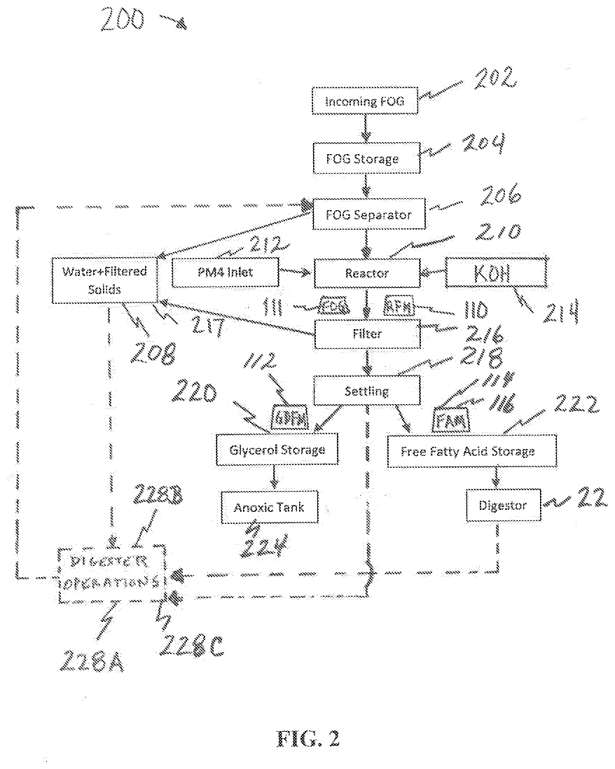

A method 200 for achieving or producing the GFDM 112 is described herein with reference to FIG. 2. In steps 202 and 204, waste organic material consisting primarily of liquid and solid FOG is received or otherwise collected and stored. In steps 206 and 208, water and solids are filtered or otherwise separated from the FOG and stored or subjected to further wastewater treatment processes consistent with sewage disposal, septic disposal or other legal means of disposal accommodated by a particular municipality.

In steps 210 and 212, enhanced saponification of the FOG is achieved in a reactor with batch or continual dosing of a saponific solution or reagent, such as for example the PM-4, thereby producing the RFM 110. Sufficient reagent is added to the FOG such that hydrolyzation of nearly all the FOG is accomplished in a suitable reactor, such as for example, a batch or flow-through reactor or reactor system. Approximately ninety percent (90%) to ninety-nine percent (99%) of the FOG breaks down or dissolves into the RFM 110 with the balance remaining as near-solid FOG. The RFM 110 is highly bio-reactive and continues to break down in aerobic and/or anaerobic systems readily such that complete oxidation or reduction (aerobic/anaerobic) of the RFM 110 is achieved in five to ten days in a static desk bench-top reactor.

In one embodiment, the method 200 includes step 214 in which a hydroxide, such as for example Potassium Hydroxide (KOH), is used to provide an ongoing pH adjustment of the RFM 110.

In step 216, water and solids or near-solid FOG 111 are filtered or otherwise separated from the RFM 110. In step 217, the near-solid FOG 111 is stored or subjected to further wastewater treatment processes. In step 218, the RFM 110 settles thereby resulting in the stratified layers of GFDM 112 disposed between the comparatively lighter FAM 114 (with respect to the GFDM 112) and the comparatively heavier FAM 116. In step 220, the GFDM 112 is filtered or otherwise separated from the RFM 110 and retained for further processing. In step 222, the FAM 114 and FAM 116 are filtered or otherwise separated from the RFM 110. In one embodiment, the method 200 includes step 224 in which the GFDM 112 is introduced to an anoxic tank for further processing as described herein below with reference to a method 300 for biological nutrient removal.

In one embodiment, the method 200 includes step 226 in which the FAM 114 and FAM 116 are passed or introduced to a digester. Optionally, in step 228A, the FAM 114 and FAM 116 are processed through the digester or digester operations and subsequently passed as additional FOG into steps 206 and 208 of the method 200 in which water and solids are filtered or otherwise separated from the FOG. In a further option, in step 228B, the water and solids resulting from steps 206 and 208 are processed through the digester or digester operations and subsequently passed or introduced as additional FOG back into steps 206 and 208 of the method 200.

In one embodiment, the method 200 includes step 228C in which the RFM 110, because of its bio reactivity, is added or introduced to an anaerobic digester system to enhance methane production and increase the economic and technical viability of anaerobic digestion processes. The RFM 110 breaks down readily, producing large quantities of methane, on a gram of methane per gram of RFM basis, and does not inhibit biological processes already in place.

Use of the GFDM 112 in biological nutrient removal processes at wastewater treatment facilities is highly effective in achieving both denitrification and enhanced phosphorus removal. In denitrification, electron donation through oxidation of the hydrocarbon allows for reduction of a nitrate (NO₃—) molecule to nitrogen gas (N₂). In enhanced phosphorus removal, additional carbon allows for an abundance of phosphorus removal from solutions and resultant reduction of phosphorus in the wastewater load to its ultimate discharge point. In both cases, downstream receiving water eutrophication is minimized in relation to the extent of nutrient removal achieved.

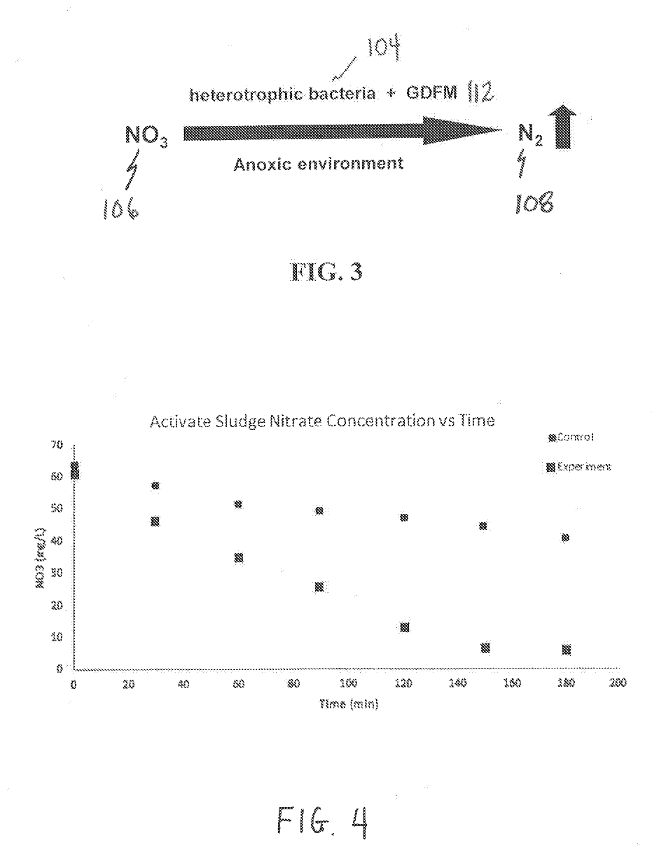

In accordance with a method 300 of the present invention, the GFDM 112 is used without dilution, with dilution or in a concentrated form, to improve biological nutrient removal processes. In one embodiment, the method 300 provides or enhances denitrification of a substance. As shown in FIG. 3, in an anoxic environment, such as for example an anoxic reactor, heterotrophic bacteria 104 use the oxygen from nitrates 106 to breakdown the GFDM 112, thereby producing nitrogen gas 108.

Typically, a fuel-derived hydrocarbon is used in denitrification processes. Most often, methanol or acetic acid has been used in these processes. Alternatively, use of the GFDM 112 is effective as an electron donor with comparable treatment results achieved. The GFDM 112 acts as a surrogate for methanol and other materials in this treatment process and is suitable to achieve the desired treatment results as well as to eliminate an otherwise ubiquitous environmental problem of excess FOG generated in food processes today.

The GFDM 112 is effective in achieving denitrification in a biological nutrient removal (“BNR”) system. In accordance with method 300, the GFDM 112 enhances biological denitrification, or electron donation in a biological denitrification reaction. The GFDM 112 acts as a methanol surrogate and readily decomposes to allow electrons to transfer to the nitrate molecule converting it to nitrogen gas. Thus, the GFDM 112 provides a replacement for a number of existing commercial products and thereby becomes a commercial product itself. Optimization of the denitrification BNR reaction achieved with the use of the GFDM 112 provides an effective, efficient and cost-competitive improvement to a BNR system.

A graph is presented in FIG. 4 showing the results of batch denitrification testing in which GFDM 112 was used in the denitrification process in comparison to a control where no additional hydrocarbon was used in the same denitrification process. In the denitrification testing, nitrate-nitrogen was denitrified using the GFDM 112 as an electron donor, i.e., a methanol substitute. The results are shown graphically as a concentration of nitrate, i.e., NO₃, expressed in milligrams per liter (mg/L) over time expressed in minutes. As shown in FIG. 4, use of the GFDM 112 in the denitrification process results in a substantial improvement to the denitrification process. For example, as shown in FIG. 4: (i) at approximately one hour into the testing, use of the GFDM 112 provided an approximately thirty percent (30%) improvement; at approximately two hours into the testing, use of the GFDM 112 provided an approximately seventy-five percent (75%) improvement; and at approximately three hours into the testing, use of the GFDM 112 provided an approximately ninety percent (90%) improvement.

The process described herein provide a carbon recycle solution for processing highly problematic concentrated waste streams composed primarily of FOG. The FOG issues impacting the U.S. municipal infrastructure are abundant and regulations controlling the discharge of FOG and its collection are nationwide in application. The processes of the present invention described herein provide a unique, beneficial reuse of this waste material, namely FOG, by treatment and subsequent production of one or more commercial products.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated invention which is not to be limited to the specific embodiment disclosed.

What is claimed is:

1. A method for denitrification of a substance having nitrate (NO₃—) molecules therein, the method comprising the steps of:
a) collecting waste organic material having fats, oils and grease (“FOG”) therein;
b) separating the FOG from the collected waste organic material;
c) mixing a saponific reagent with the FOG thereby initiating a saponification reaction to hydrolyze the FOG to fatty acid and forming a resultant FOG mixture (“RFM”) having stratified layers of one or more fatty acid mixtures (“FAM”) and a glycerol fraction derived mixture (“GFDM”); and
d) mixing the GFDM with the substance in an anoxic environment wherein heterotrophic bacteria use oxygen from the nitrate (NO₃—) molecules to breakdown the GFDM thereby producing nitrogen gas.

2. The method of claim 1, wherein the saponific reagent is a plant-based, biodegradable degreaser.

3. The method of claim 2, wherein the plant-based, biodegradable degreaser is a vegetable-based protein mixture.

4. The method of claim 2, wherein the resultant FOG mixture (“RFM”) is a flowable liquid byproduct.

5. The method of claim 1, wherein the step of mixing a saponific reagent with the FOG is achieved in a reactor with batch dosing of the saponific reagent.

6. The method of claim 1, wherein the step of mixing a saponific reagent with the FOG is achieved in a reactor with continual dosing of the saponific reagent.

7. The method of claim 1, wherein the fatty acid mixture (“FAM”) comprises a fatty acid salt mixture.

8. The method of claim 1, wherein the resultant FOG mixture (“RFM”) is bio-reactive in an aerobic processes.

9. The method of claim 1, wherein the resultant FOG mixture (“RFM”) is bio-reactive in an anaerobic processes.

10. The method of claim 1, wherein the resultant FOG mixture (“RFM”) comprises a layer of the glycerol fraction derived mixture (“GFDM”) disposed between a comparatively lighter layer of the fatty acid mixture (“FAM”) with respect to the GFDM, and a comparatively heavier layer of the FAM with respect to the GFDM.

11. The method of claim 1, wherein the step of mixing a saponific reagent with the FOG includes dosing of the reagent together with a hydroxide for ongoing pH adjustment.

12. The method of claim 11, wherein the hydroxide comprises Potassium Hydroxide (KOH).

13. The method of claim 1, wherein the glycerol fraction derived mixture (“GFDM”) comprises a bio-reactive dissolved organic carbon mixture.

14. The method of claim 1, wherein ninety percent (90%) to ninety-nine percent (99%) of the FOG dissolves into the resultant FOG mixture (“RFM”) with the balance remaining as near-solid FOG.

15. The method of claim 1, wherein the resultant FOG mixture (“RFM”) continues to break down in aerobic systems such that complete oxidation of the RFM is achieved in five to ten days in a static desk bench-top reactor.

16. The method of claim 1, wherein the resultant FOG mixture (“RFM”) continues to break down in anaerobic systems such that complete reduction of the RFM is achieved in five to ten days in a static desk bench-top reactor.

17. The method of claim 1, wherein the fatty acid mixture (“FAM”) is introduced into a digester.

18. The method of claim 17, wherein the step of collecting FOG includes receiving the fatty acid mixture (“FAM”) that passes through the digester.

19. The method of claim 1, further including a step in which the resultant FOG mixture (“RFM”) is introduced into an anaerobic digester system where it breaks down thereby producing large quantities of methane on a gram of methane per gram of RFM basis.
